(19) United States
(12) Patent Application Publication
(10) Pub. No.: US 2016/0036608 A1
(43) Pub. Date: Feb. 4, 2016

(54) METHOD AND APPARATUS FOR SERIAL BUS COMMUNICATION BASED ON ORTHOGONAL SIGNAL WAVEFORM

(71) Applicant: ELECTRONICS AND TELECOMMUNICATIONS RESEARCH INSTITUTE, Daejeon (KR)

(72) Inventors: Joo Hyun LEE, Daejeon (KR); Ju-Yeob KIM, Daejeon (KR)

(21) Appl. No.: 14/742,421

(22) Filed: Jun. 17, 2015

(30) Foreign Application Priority Data
Jul. 29, 2014 (KR) 10-2014-0096777

(51) Int. Cl. H04L 27/26; H04L 12/40

(52) U.S. Cl. CPC H04L 27/2602; H04L 12/40

(57) ABSTRACT

A first communication device is provided. The first communication device modulates data to generate a first data symbol. The first communication device generates a first signal by using a first signal waveform allocated among a plurality of mutually orthogonal signal waveforms and the first data symbol. The first communication device outputs the first signal to a serial line connected to a second communication device.

### CROSS-REFERENCE TO RELATED APPLICATION

This application claims priority to and the benefit of Korean Patent Application No. 10-2014-0096777 filed in the Korean Intellectual Property Office on Jul. 29, 2014, the entire contents of which are incorporated herein by reference.

### BACKGROUND OF THE INVENTION

(a) Field of the Invention

The present invention relates to a communication device and a communication method.

(b) Description of the Related Art

A serial bus technique based on inter-integrated circuit communication (I2C) allows for direct transmitting and receiving data of a logic signal (for example, “1” or “0”) and supports a relatively low data transfer rate.

Also, a related art data transmitting and receiving technique requires a process of selecting one slave device by a master device. The related art data transmitting and receiving technique supports only communication between one master device and one slave device at a time. Thus, voluntary communication between slave devices is not possible, and only communication between one master device and one slave device selected from among slave devices is possible.

Demand for simple data connection has steadily been made in various fields, but due to requirements such as a high data transfer rate, or the like, an existing parallel connection scheme has been used so far. A problem such as complexity of connection caused due to the parallel connection scheme has been solved through miniaturization of systems.

### SUMMARY OF THE INVENTION

The present invention has been made in an effort to provide a device and method having advantages of performing fast data transmission and reception in a bus form between several devices through a simple serial connection structure without complicated connections.

An exemplary embodiment of the present invention provides a first communication device. The first communication device may include: a symbol generator configured to modulate data to generate a first data symbol; and a signal generator configured to generate a first signal using a first signal waveform allocated among a plurality of mutually orthogonal signal waveforms and the first data symbol, and output the first signal to a serial line connected to a second communication device.

The serial line may add up the first signal and a second signal output from the second communication device to mix the first and second signals.

The second signal may be generated by using a second signal waveform orthogonal to the first signal waveform among the plurality of signal waveforms.

The signal generator may include a first generator configured to generate the first signal waveform by cyclic-shifting a basic signal waveform among the plurality of waveforms by a first shift value corresponding to the first signal waveform.

The signal generator may further include a second generator configured to generate the first signal by multiplying the first data symbol by the first signal waveform.

The mixed signal mixed by the serial line may include: a first identifier identifying a device to receive a first packet corresponding to the first signal; length information indicating a length of the first packet; and a second identifier identifying a device transmitting the first packet.

The communication device may further include a reception processor configured to receive the mixed signal from the serial line and obtain data whose destination is the first communication device from the mixed signal.

When an identifier of a reception device of the first packet indicating a device to receive a first packet among packets included in the mixed signal indicates the first communication device, the reception processor may extract data from the first packet by using a basic signal waveform among the plurality of signal waveforms.

The first packet may correspond to the second signal.

When the identifier of a reception device of the first packet indicates the first communication device, the signal generator may generate a response signal with respect to the first packet by using a third signal waveform corresponding to signal waveform information included in the first packet, among the plurality of signal waveforms, and output the response signal to the serial line.

In order to receive allocation of the first signal waveform, the signal generator may generate a third signal requesting allocation of a signal waveform by using a third signal waveform reserved for an allocation request among the plurality of signal waveforms, and output the third signal to the serial line.

The first communication device may further include a capacitor positioned between the signal generator and the serial line for capacitive coupling.

When the capacitor is formed within a semiconductor chip, the capacitor may correspond to a pattern formed between layers of the semiconductor chip.

When the capacitor is formed within a semiconductor chip package, the capacitor may correspond to a pattern formed on a substrate of the semiconductor chip package.

When the capacitor is formed outside of a semiconductor chip package, the capacitor may include a first terminal in the form of a film, and a support preventing a short-circuit between the first terminal and a second terminal of a board.

Another embodiment of the present invention provides a first communication device. The first communication device may include: a waveform allocator configured to manage a plurality of mutually orthogonal signal waveforms, and allocate a first signal waveform among the plurality of signal waveforms to a second communication device among a plurality of communication devices connected to a serial line; and a signal generator configured to generate a first signal by using allocation information of the first signal waveform and a second signal waveform among the plurality of signal waveforms, and output the first signal to the serial line.

When energy exists in a third signal waveform reserved for an allocation request among the plurality of signal waveforms, the waveform allocator may determine that at least one of the plurality of communication devices requests allocation of a signal waveform.

The first communication device may further include a reception processor configured to receive the mixed signal from the serial line and extract information whose destination is the first communication device from the mixed signal.

When the extracted information indicates transmission completion of the second communication device, the waveform allocator may collect the first signal waveform.

The waveform allocator may allocate the first signal waveform such that the second communication device can continuously use the first signal waveform, and collect the first signal waveform at a point in time when the second communication device does not require the first signal waveform.

The first communication device may further include a synchronization pulse generator configured to output a time synchronization pulse distinguished from the plurality of signal waveforms to the serial line at every predetermined number of frames.

The frame may correspond to one period of the first signal waveform.

Yet another embodiment of the present invention provides a communication method of a first communication device. The communication method may include: receiving allocation of a first signal waveform among a plurality of mutually orthogonal signal waveforms; modulating data to generate a first data symbol; generating a first signal by using the first signal waveform and the first data symbol, and outputting the first signal to a serial line; and receiving a mixed signal from the serial line.

The mixed signal may be a signal obtained by adding up the first signal and a second signal output from a second communication device connected to the serial line by the serial line.

### BRIEF DESCRIPTION OF THE DRAWINGS

FIG. 1 is a view illustrating a system according to an exemplary embodiment of the present invention.

FIG. 2 is a view illustrating configurations of devices and transmission and reception operations of the devices according to an exemplary embodiment of the present invention.

FIG. 3 is a view illustrating a configuration of a master device according to an exemplary embodiment of the present invention.

FIG. 4 is a view illustrating a signal structure on a serial line.

FIG. 5 is a view illustrating signal summation through capacitive coupling.

FIG. 6 is a view illustrating a method for realizing a single device using a semiconductor chip.

FIG. 7 is a view illustrating a computer system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

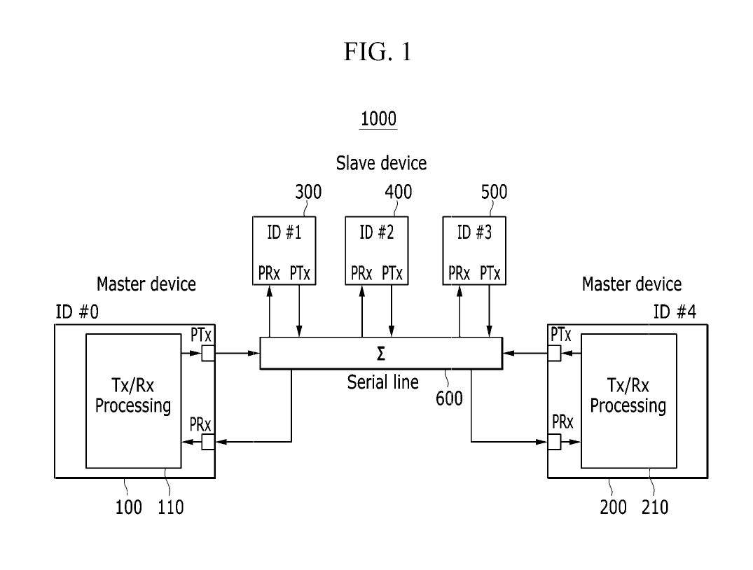

FIG. 1 is a view illustrating a system 1000 according to an exemplary embodiment of the present invention.

The system 1000 includes at least one of master devices 100 and 200, at least one of slave devices 300, 400, and 500, and a serial line 600. In FIG. 1, a case in which the system 1000 includes two master devices 100 and 200 and three slave devices 300, 400, and 500 is illustrated.

All the devices 100 to 500 are connected to the common serial line 600. The serial line 600 is a line for serial communication.

All the devices 100 on the serial line 600 have a unique device identifier (e.g., an ID or an address value) given according to separate methods, and the devices 100 to 500 are identified using the device identifiers. In FIG. 1, for the purposes of description, a case in which the master device 100 has ID 0 as a device identifier, the master device 200 has ID 4 as a device identifier, the slave device 300 has ID 1 as a device identifier, the slave device 400 has ID 2 as a device identifier, and the slave device 500 has ID 3 as a device identifier is illustrated.

The master devices 100 and 200 include signal processors 110 and 210 processing signal transmission and reception. The signal processors 110 and 210 output a signal to the serial line 600 through a transmission port PTx, and receive a signal from the serial line 600 through a reception port PRx. The slave devices 300 to 500 may also have the same configuration as or similar to the transmission and reception processors 110 and 120. The slave devices 300 to 500 may receive a signal from the serial line 600 through a reception port PRx and output a signal to the serial line 600 through a transmission port PTx.

The serial line 600 serves to add and mix signals output from all of the devices 100 to 500. The signal mixed (hereinafter referred to as a “mixed signal”) by the serial line 600 is input to all of the devices 100 to 500 on the serial line.

Each of the devices 100 to 500 transmits a signal having a continuous signal waveform using several orthogonal signals. This is different from an existing transmission and reception scheme of directly transmitting a logic signal corresponding to bit data (e.g., “0” and “1”).

In detail, in a case in which a set (an aggregation) S_{W} of M (M is a natural number) signal waveforms having mutually orthogonal properties are present as expressed by Equation 1, each of the signal waveforms Φₘ belonging to the set (the aggregation) S_{W} may be defined as expressed by Equation 2.

S_{W}={Φ₀,Φ₁,Φ₂, . . . ,Φ_{M-1}} (Equation 1)

Φₘ=φₘ(n), (Equation 2)
m=0, 1, . . . , M−1
n=0, 1, . . . , N−1

In Equation 2, φₘ denotes a function for an m-th signal waveform Φₘ, and to N (N is a natural number) denotes a length of the signal waveform Φₘ.

Each signal waveform Φₘ has mutually orthogonal properties. Orthogonal properties between the signal waveforms Φₘ may be expressed by Equation 3.

$$\begin{matrix}{Φ}_{i} \cdot {Φ}_{j} ≡ 〈 {Φ}_{i} , {Φ}_{j} 〉 \\ ≡ {\sum }_{n} {ϕ}_{i} ( n ) \cdot {ϕ}_{j}^{*} ( n ) = \{ \begin{matrix}0 & i \neq j \\ A 1 & i = j\end{matrix}\end{matrix} \qquad ( Equation 3 )$$

In Equation 3, A1 denotes a constant, and i and j denote signal waveform indices. For example, a continuous signal waveform Φ₀ and a continuous signal waveform Φ₂ are orthogonal to each other.

Unlike the existing scheme of transmitting logic data signifying a bit of “1” or “0” in the form of a pulse, the devices 100 to 500 transmit and receive data using M number of continuous signal waveforms Φₘ having mutually orthogonal properties.

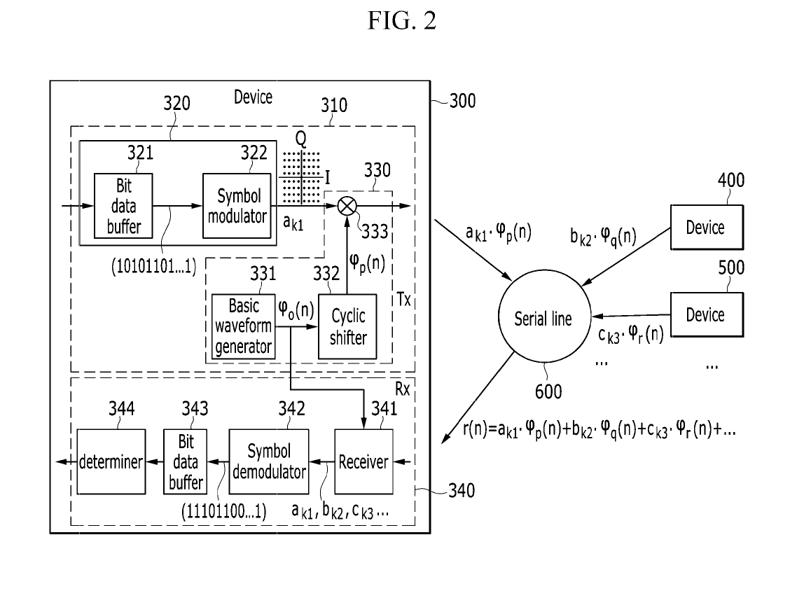

A method of generating the continuous signal waveforms Φₘ having mutually orthogonal properties by the devices 100 to 500 will be described in detail with reference to FIG. 2.

FIG. 2 is a view illustrating configurations of devices 300 to 500 and transmission and reception operations of the devices 300 to 500 according to an exemplary embodiment of the present invention. In FIG. 2, for the purposes of description, three slave devices 300 to 500 connected to the serial line 600 are illustrated.

The slave device 300 includes a transmission processor 310 processing signal transmission and a reception processor 340 processing signal reception.

The transmission processor 310 includes a symbol generator 320 and a signal generator 330. The symbol generator 320 modulates bit data to generate a data symbol. In detail, the symbol generator 320 includes a bit data buffer 321 buffering bit data and a symbol modulator 322 modulating output data from the bit data buffer 321 into a data symbol. The symbol modulator 322 may use an I/Q modulation scheme.

The signal generator 330 generates a continuous signal waveform Φₘ, generates a signal using the data symbol and the continuous signal waveform Φₘ, and outputs the same. In detail, the signal generator 330 includes a basic waveform generator 331, a cyclic shifter 332, and a multiplier 333. The basic waveform generator 331 generates a basic signal waveform Φ₀. The cyclic shifter 332 cyclic-shifts the basic signal waveform Φ₀ to generate a continuous signal waveform Φₘ. For example, the cyclic shifter 332 may generate the continuous signal waveform Φₘ using Equation 4.

$$\begin{matrix}{Φ}_{m} = {ϕ}_{m} ( n ) \\ = {ϕ}_{0} ( n + mod ( {S}_{m} , N ) ) ,\end{matrix} \\ m = 0 , 1 , … , M - 1 n = 0 , 1 , … , N - 1 \qquad ( Equation 4 )$$

The cyclic shifter 332 cyclic-shifts a basic signal waveform φ₀(n) by a cyclic shift value Sₘ to generate a continuous signal waveform φₘ (n). The cyclic shift value Sₘ corresponds to the continuous signal waveform φₘ(n). For example, the cyclic shifter 332 may cyclic-shift the basic signal waveform φ₀(n) by a cyclic shift value S₂ to generate a continuous signal waveform φ₂(n). That is, the signal generator 330 may generate a plurality of continuous signal waveforms φₘ(n) having mutually orthogonal properties, while changing the cyclic shift value Sₘ from one basic signal waveform φ₀(n). Meanwhile, each of the devices 100 to 500 connected to the serial line 600 transmits and receives a signal or data by using at least one continuous signal waveform allocated thereto, among M number of available continuous signal waveforms φₘ(n).

The multiplier 333 multiplies the data symbol output from the symbol generator 320 by the continuous signal waveform Φₘ. A signal output from the multiplier 333 is transmitted to the serial line 600.

The reception processor 340 includes a receiver 341, a symbol demodulator 342, a bit data buffer 343, and a determiner 344.

The receiver 341 receives a mixed signal from the serial line 600. The receiver 341 extracts a data symbol from the mixed signal using the basic signal waveform Φ₀. The symbol demodulator 342 demodulates the data symbol to bit data. The bit data buffer 343 buffers the bit data. The determiner 344 determines data whose destination is the slave device 300 among output data from the bit data buffer 343.

The slave devices 400 and 500 may have the same configuration as or similar to that of the slave device 300.

A signal transmission operation of the slave devices 300 to 500 will be described in detail with reference to FIG. 2. For example, the slave device 300 demodulates bit data to be transmitted (e.g., 10101101 . . . 1) into a data symbol aₖ₁ (k1=0, 1, . . . , X−1, X is a natural number). The slave device 400 demodulates bit data to be transmitted into a data symbol bₖ₂ (k2=0, 1, . . . , Y−1, Y is a natural number). The slave device 500 modulates bit data to be transmitted into a data symbol cₖ₃ (k3=0, 1, . . . , Z−1, Z is a natural number).

Each of the slave devices 300 to 500 generates a continuous signal waveform φₘ(n) by applying different cyclic shift values Sₘ to the basic signal waveform φ₀(n). The three slave devices 300 to 500 are allocated continuous signal waveforms φₘ(n) which do not overlap each other. For example, a continuous signal waveform φₚ(n) allocated to the slave device 300, a continuous signal waveform φ_{q}(n) allocated to the slave device 400, and a continuous signal waveform φᵣ(n) allocated to the slave device 500 are different.

Each of the slave devices 300 to 500 multiplies the symbols aₖ₁, bₖ₂, and cₖ₃ by the continuous signal waveforms φₚ(n), φ_{q}(n), and φᵣ(n) having an allocated length of N, respectively, and outputs the same to the serial line 600. For example, when the slave device 300 is allocated three continuous signal waveforms φ₂(n), φ₃(n), and φ₄(n), an output signal aₖ₁·φₚ(n) from the slave device 300 may be expressed by Equation 5.

$${a}_{k 1} \cdot {ϕ}_{p} ( n ) = {a}_{0} [ {ϕ}_{2} ( 0 ) , {ϕ}_{2} ( 1 ) , … , {ϕ}_{2} ( N - 1 ) ] + {a}_{1} [ {ϕ}_{3} ( 0 ) , {ϕ}_{3} ( 1 ) , … , {ϕ}_{3} ( N - 1 ) ] + {a}_{2} [ {ϕ}_{4} ( 0 ) , {ϕ}_{4} ( 1 ) , … , {ϕ}_{4} ( N - 1 ) ] \qquad ( Equation 5 )$$

As in Equation 5, one data symbol is multiplied by one continuous signal waveform. That is, the data symbol a₀ is multiplied by the continuous signal waveform φ₂(n), the data symbol a₁ is multiplied by the continuous signal waveform φ₃(n), and the data symbol a₂ is multiplied by the continuous signal waveform φ₄(n). The slave devices 400 and 500 output the signal bₖ₂·φ_{q}(n) and the signal cₖ₃·φᵣ(n), respectively, in a similar manner. The output signals from the devices 300 to 500 on the serial line 600 may be added up on the serial line 600 so as to be mixed. The mixed signal is input to each of the devices 100 to 500 on the serial line 600. Thus, the mixed signal r(n) received by all of the devices 100 to 500 on the serial line 600 may be expressed by Equation 6.

r(n)=aₖ₁·ωₚ(n)+bₖ₂·φ_{q}(n)+cₖ₃·φᵣ(n) (Equation 6)

Each of the devices 100 to 500 of the serial line 600 extracts data whose destination is the devices 100 to 500, respectively, from the mixed signal r(n). For example, the reception processor 340 of the slave device 300 extracts the data symbols aₖ₁, bₖ₂, and cₖ₃ from the mixed signal r(n) by using the basic signal waveform φ₀(n), and demodulates the data symbols aₖ₁, bₖ₂, and cₖ₃ into bit data. The reception processor 340 of the slave device 300 distinguishes data whose destination is the slave device 300, from the modulated bit data.

Meanwhile, the master devices 100 and 200 may have the same configuration as or similar to that of the device 300. As described above, signals output from the master devices 100 and 200 may be mixed with a signal output from other device on the serial line 600, in the serial line 600, and the mixed signal may be input to the master devices 100 and 200. For example, when the master device 100 and the slave device 400 outputs signals, the output signal from the master device 100 and the output signal from the slave device 400 are added up through the serial line 600.

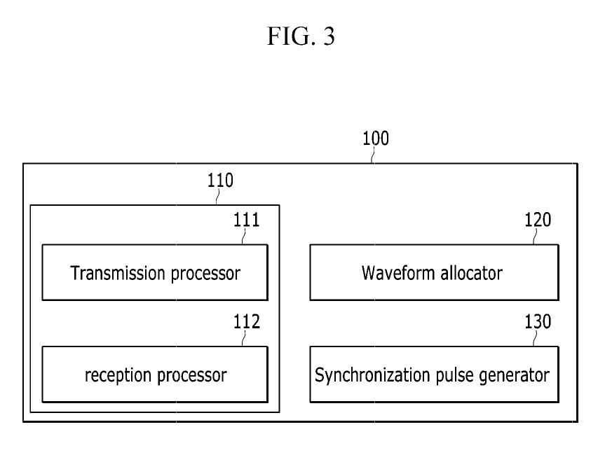

FIG. 3 is a view illustrating a configuration of the master device 100 according to an exemplary embodiment of the present invention. The master device 200 has the same configuration as or similar to that of the master device 100.

The master device 100 owns and manages continuous signal waveforms given to the master device 100. The master device 100 uses a continuous signal waveform in order to transmit and receive a signal or data to and from the slave devices 300 to 500 or the other master device 200 on the serial line 600. As described above, the devices 100 to 500 connected to the serial line 600 use continuous signal waveforms in order to transmit a signal or data. If a plurality of master devices 100 and 200 exist in the serial line 600, the master devices 100 and 200 have M number of available continuous signal waveforms divided according to a predetermined method, and manage the continuous signal waveforms that the master devices 100 and 200 have authority to control. For example, when it is assumed that M=10, the master device 100 may manage 0^{th} to 6th continuous signal waveforms among a total of ten available continuous signal waveforms, and the master device 200 may manage 7^{th} to 9^{th} continuous signal waveforms.

In detail, the master device 100 includes the signal processor 110, a waveform allocator 120, and a synchronization pulse generator 130.

The signal processor 110 includes a transmission processor 111 and a reception processor 112. The transmission processor 111 performs a function or an operation that is the same as or similar to that of the transmission processor 310 of the slave device 300. The reception processor 112 performs a function or an operation that is the same as or similar to that of the reception processor 340 of the slave device 300.

The waveform allocator 120 manages a plurality of continuous signal waveforms and allocates a continuous signal waveform to other devices on the serial line 600. In detail, in a case in which another device (e.g., the device 300) on the serial line 600 needs to transmit data using a waveform controlled by the waveform allocator 120, the waveform allocator 120 allocates at least one of continuous signal waveforms controlled by the waveform allocator 120 to the other device 300 such that the device 300 may transmit data. Thereafter, when the operation of the corresponding device 300 is completed, the waveform allocator 120 collects the continuous signal waveform which has been allocated to the corresponding device 300. A waveform allocation scheme of the waveform allocator 120 includes an automatic allocation scheme and a regulative allocation scheme. In detail, the automatic allocation scheme is a scheme in which the master device 100 allocates a continuous signal waveform to the corresponding device 400, and when the operation of the corresponding device 400 is completed, the corresponding device 400 itself immediately returns the allocated continuous signal waveform. The regulative allocation scheme is a scheme in which the master device 100 semi-permanently allocates a continuous signal waveform to the corresponding device 500 such that the device 500 may continuously use the continuous signal waveform, and when the corresponding device 500 does not need the continuous signal waveform any longer, the master device 100 collects the continuous signal waveform from the corresponding device 500.

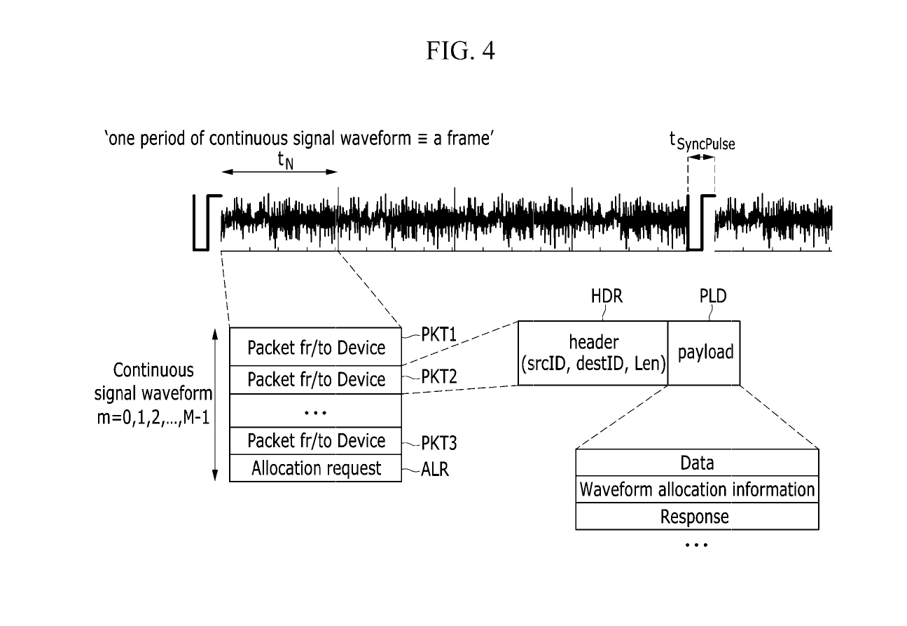

The synchronization pulse generator 130 generates a simple time synchronization pulse signal, definitely distinguished from the continuous signal waveform, and transmits the same. The synchronization pulse generator 130 will be described in more detail with reference to FIG. 4.

Meanwhile, in communication between the master devices 100 and 200, each of the master devices 100 and 200 operates as a slave device with respect to the other of the master devices 100 and 200. For example, in a case in which the master device 200 requests the master device 100 to output a signal using a continuous signal waveform controlled by the master device 200, the master device 100 may perform every operation of the slave device such as an operation of outputting a signal by using a continuous signal waveform allocated from the master device 200.

FIG. 4 is a view illustrating a signal structure on the serial line 600.

A time duration in which data corresponding to one period (from n=0 to n=N−1) of a continuous signal waveform is transmitted is t_{N}, and this time duration is called a frame. The frame corresponds to one period of a continuous signal frame. A data bundle transmitted to each of the devices 100 to 500 is called a packet. Each of the devices 100 to 500 may transmit several packets to the other devices 100 to 500. Also, each of the devices 100 to 500 may receive several packets from the other devices 100 to 500.

The packets PKT1 to PKT3 transmitted from the devices 100 to 500 are included together in a single frame. The packets PKT1 to PKT3 included in the single frame may be transmitted to a portion or the entirety of M number of continuous signal waveforms.

Each of the packets PKT1 to PKT3 includes a header HDR and a payload PLD. The header HDR includes an address value (or a device ID) of a reception device indicating a device to receive a packet, length information indicating a length of a packet, and an address value (or a device ID) of a transmission device indicating a device which has transmitted a packet. For example, when the slave device 400 transmits the packet PKT1 to the master device 100, a header HDR of the packet PKT1 includes an address value of a transmission device indicating the slave device 400, an address value of a reception device indicating the master device 100, and length information of the packet PKT1. For example, when the slave device 300 transmits the packet PKT2 to the slave device 500, a header of the packet PKT2 includes an address value of a transmission device indicating the slave device 300, an address value of a reception device indicating the master device 500, and length information of the packet PKT2. The payload PLD may include data (e.g., a data symbol), waveform allocation information, or response information.

Each of the devices 100 to 500 on the serial line 600 receives all the packets PKT1 to PKT3 included in each frame, and identifies data corresponding to each of the devices 100 to 500 using the reception device address values of the packets PKT1 to PKT3.

Meanwhile, a single frame may include an allocation request signal (ALR). In detail, in a case in which a continuous signal waveform has been allocated to each of the devices 100 to 500 on the serial line 600, each of the devices 100 to 500 may transmit data using the allocated continuous signal waveform. However, in a case in which a device (e.g., the device 300) has not been allocated a continuous signal waveform, the device 300 should wait until a waveform is allocated. In a case in which the slave devices 300 to 500 have not been allocated a continuous signal waveform yet but they should transmit data, the slave devices 300 to 500 request the master devices 100 and 200 to allocate a signal waveform. In detail, each of the master devices 100 and 200 allocates at least one continuous signal waveform, among continuous signal waveforms controlled by each of the master devices 100 and 200, to each frame. The slave devices 300 to 500 may request the master devices 100 and 200 to allocate a signal waveform, by using a signal waveform reserved for an allocation request (hereinafter referred to as an “allocation request signal waveform”). The several devices (e.g., the devices 100 to 500) may share and use the allocation request signal waveform. When the master devices 100 and 200 receive the allocation request signal waveform, the master devices 100 and 200 simply detect whether energy (e.g., a signal magnitude, etc.) exists in the allocation request signal waveform, rather than detecting a data symbol included in a signal of the allocation request signal waveform. For example, in a case in which the master device 100 determines 0^{th} and 1^{st} continuous signal waveforms, among seven continuous signal waveforms controlled by the master device 100, as signal waveforms for an allocation request, the slave device 300 may request the master device 100 to allocate a signal waveform for data transmission, by using at least one of the 0^{th} and first continuous signal waveforms. Here, the slave device 300 may transmit an allocation request signal ALR, which is a signal of the allocation request signal waveform. In a case in which energy exists in the 0^{th} and 1^{st} continuous signal waveforms as allocation request signal waveforms, the master device 100 may determine that at least one of the devices 200 to 500 connected to the serial line 600 requests allocation of a continuous signal waveform. In a case in which the allocation request is received, the master device 100 may check each of the slave devices 300 to 500 to recognize which of the slave devices 300 to 500 has requested an interrupter, and allocate a signal waveform for data transmission to the device (e.g., the device 300) which has requested the interrupter.

Meanwhile, one (e.g., the master device 100 or 200) among all of the devices 100 to 500 of the serial line transmits a time synchronization pulse signal during a t_{SyncPulse} interval at every predetermined number of frames (for example, every four frames). The devices 100 to 500 on the serial line 600 may adjust temporal synchronization with other devices by using a time synchronization pulse signal for a signal transmission and reception on the serial line 600. If the time synchronization pulse signal is not present, the devices 100 to 500 on the serial line 600 should search for temporal synchronization through complicated calculation using a reception signal. However, as illustrated in FIG. 4, in a case in which the time synchronization pulse is used, the devices 100 to 500 on the serial line 600 may easily adjust temporal synchronization of mutual signals.

Meanwhile, the slave devices 300 to 500 may receive all the packets PKT1 to PKT3 on the serial line 600, but when data transmission is required, the slave devices 300 to 500 should use the continuous signal waveform allocated from the master devices 100 and 200. That is, the slave devices 300 to 500 constantly receive all the data on the serial line 600, and extract a packet whose destination is the slave devices 300 to 500. In a case in which there is a data transmission request in the extracted packet, the slave devices 300 to 500 transmits data by using continuous signal waveforms allocated from the master devices 100 and 200.

Meanwhile, each of the devices 100 to 500 on the serial line 600 receives and interprets all the packets PKT1 to PKT3 included in the frame output from the serial line 600, and identifies a packet whose destination is each of the devices 100 to 500. Thus, each of the devices 100 to 500 on the serial line 600 may receive a data reception or data transmission request from a plurality of other devices, within one frame.

Meanwhile, a data flow among the devices 100 to 500 connected to the serial line 600 is as follows. Communication between the master devices 100 and 200 and the slave devices 300 to 500 is performed as the master devices 100 and 200 directly request data from the slave devices 300 to 500. Communication between the slave devices (e.g., the devices 300 and 400) may be performed as the master device (e.g., the device 100) allocates a continuous signal waveform to the slave device 300 required to output a signal, and the slave device 300, which has allocated the continuous signal waveform, requests data from the other slave device 400. Communication between the master devices (e.g., the devices 100 and 200) may be performed in the same manner as that between the master devices 100 and 200 and the slave devices 300 to 500 described above since the counter master device (e.g., the device 200) operates in the same manner as that of the slave devices.

Meanwhile, in a case in which the master device (e.g., the device 100) reads data from another device (e.g., the device 300) on the serial line 600, the master device 100 requests the data from the corresponding device 300 and simultaneously informs about a continuous signal waveform to be used by the corresponding device 300 when transmitting the data. Here, payload PLD of a packet output from the master device 100 includes waveform allocation information indicating a continuous signal waveform to be used by the corresponding device 300. When transmission of data from the corresponding device 300 is completed, the master device 100 collects the continuous signal waveform allocated to the corresponding device 300 and uses it for a different purpose.

Meanwhile, the master device (e.g., the device 100) may request a device (e.g., the device 400) on the serial line 600 to transmit data to another device (e.g., the device 300). To this end, the master device 100 allocates a continuous signal waveform to be used by the device 400 to transmit data. When the transmission operation of the device 400 is completed, the device 400 informs the master device 100 that the operation has been completed. The master device 100 may collect the continuous signal waveform allocated to the device 400 or may allow the device 400 to continuously use the allocated continuous signal waveform. Accordingly, data may be moved even without involvement of the master device 100. The master device 100 may allocate a portion of continuous signal waveforms controlled by the master device 100 to data transmission between the devices 300 and 400, and continue its operation as a master device by using the other remaining continuous signal waveforms. In order to allow autonomous data transmission to be more conveniently performed between the slave devices 300 and 400, the master device 100 may semi-permanently allocate a continuous signal waveform to a particular device (e.g., the device 400) to which data transmission frequently occurs.

Meanwhile, a response scheme of each of the devices 100 to 500 connected to the serial line 600 is as follows. When a device (e.g., the device 400) on the serial line 600 transmits a data packet, a device (e.g., the device 300) which has received the data packet transmits a response with respect to the received packet to the transmission device 400. Here, types of response may include WAIT, ACK, NACK, and NONE. In detail, a WAIT response indicates that a reception device (e.g., the device 300) has received a packet, the received packet does not have an error, a delay time is required until a request operation of the packet is completed, and the request operation is currently in progress. The ACK response indicates that the reception device 300 has received a packet, the received packet does not have an error, there is no request operation of the packet, or a request operation has been completed after the WAIT response. The NACK response indicates that reception device 300 has received a packet, but the received packet has an error. The NONE response indicates that the device 300 has not received a packet, and thus there is no response. The reception device 300 transmits a response (e.g., WAIT, ACK, or NACK) by using the continuous signal waveform included in waveform allocation information with reference to the waveform allocation information included in the data packet when the transmission device 400 transmits the packet.

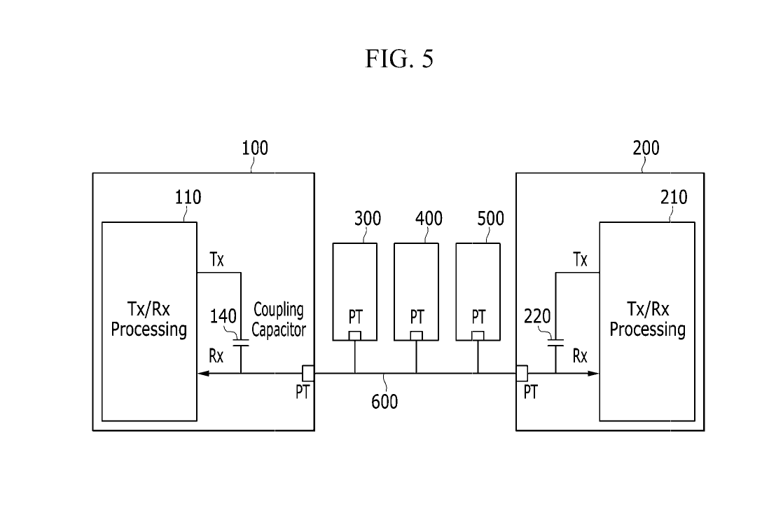

FIG. 5 is a view illustrating signal summation through capacitive coupling.

The serial line 600 serves to add up and mix the signals outputs from all the devices 100 to 500. The signal mixed by the serial line 600 is input to all the devices 100 to 500. The serial line 600 may be implemented as illustrated in FIG. 5.

In order to allow the output signals from the devices 100 to 500 on the serial line 600 to be smoothly added up without interference or attenuation thereamong, the devices 100 to 500 may include capacitors 140 and 220 for capacitive coupling. In FIG. 5, for the purposes of description, the capacitors 140 and 220 positioned on the output sides of the master devices 100 and 200 are illustrated, but the slave devices 300 to 500 may include the capacitors (not shown) positioned on the output sides in the same manner as that of the master devices 100 and 200. The output sides of the devices 100 to 500 may be separated through the capacitors (e.g., 140 and 220) of the devices 100 to 500, eliminating interference between output signals, and thus the output signals of the devices 100 to 500 may be smoothly added up. The serial line 600 connecting the several devices 100 to 500 and adding up the output signals from the devices 100 to 500 may be realized only through a simple conducting wire by using capacitive coupling, without a special device.

Meanwhile, since the serial line 600 is configured such that the mixed signal of the serial line 600 is directly applied to reception sides of the devices 100 to 500, the reception sides of the devices 100 to 500 may receive the mixed signal.

Meanwhile, in FIG. 5, a case in which each of the devices 100 to 500 includes a single port PT is illustrated. Each of the devices 100 to 500 may normally perform a transmission operation and a reception operation of a signal only with the single port PT through the capacitors (e.g., 140 and 220) thereof. For example, the capacitor 140 may be positioned between the output side (e.g., the transmission processor 111) of the master device 100 and the port PT, and the reception side of the master device 100 may be directly connected to the port PT without a capacitor.

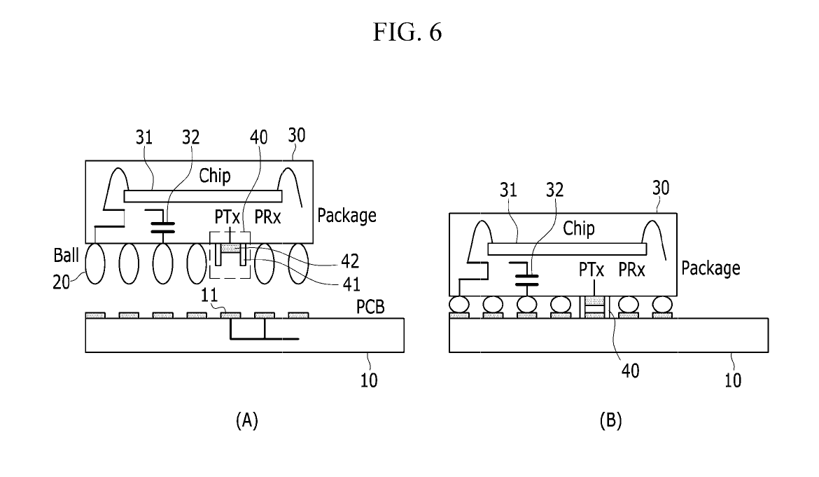

FIG. 6 is a view illustrating a method for realizing a single device 100 to 500 using a semiconductor chip 31. In FIG. 6, (A) is a view illustrating a state in which a package 30 including a semiconductor chip 31 and a printed circuit board (PCB) 10 come into contact, and (B) is a view illustrating a state in which the package 30 and the PCB 10 are in contact. The semiconductor chip 31 corresponds to one of the devices 100 to 500.

Capacitors 32 and 40 for capacitive coupling may be formed within each of the devices 100 to 500.

The capacitor 32 in a first form may be provided within the package 30 through a pattern formed on a substrate of the package 30. The capacitors 140 and 220 of FIG. 5 may be formed in the same manner as that of the capacitor 32 of FIG. 6.

Meanwhile, the capacitor 40 in a second form provided outside of the package 30 includes a terminal portion 42 in the form of a thin film and a support 41. The capacitor 40 may be used instead of a ball 20 allowing the package 30 and the PCB 10 to be brought into contact with each other. In order to prevent the terminal portion 42 of the capacitor 40 and a terminal portion 11 of the PCB 10 from being short-circuited, the support 41 may be disposed to cover the terminal portion 42. The terminal portion 42 of the capacitor 40 is connected to a transmission port (e.g., PTx).

Meanwhile, a capacitor in a third form may be formed within the semiconductor chip 31 through a pattern formed between layers of the semiconductor chip 31 during a semiconductor manufacturing process.

In order to allow the output signals from the devices 100 to 500 to be smoothly added up on the serial line 600, at least one of the capacitors (not shown, 32 and 40) in first to third forms may be formed within each of the devices 100 to 500.

As described above, the exemplary embodiment of the present invention relates to a fast serial bus technique. The devices 100 to 500 connected to the serial line 600 transmit signals using at least one of a plurality of continuous signal waveforms having mutually orthogonal properties. Signals output from the several devices 100 to 500 are all mixed to be added up on the single serial line 600. The mixed signal of the serial line 600 is input to the reception side of each of the devices 100 to 500. The devices 100 to 500 receive the entire mixed signal and separate own data from the mixed signal. A communication scheme according to an exemplary embodiment of the present invention is different from the existing transmission and reception scheme of transmitting a logic signal signifying bit data of “0” and “1”.

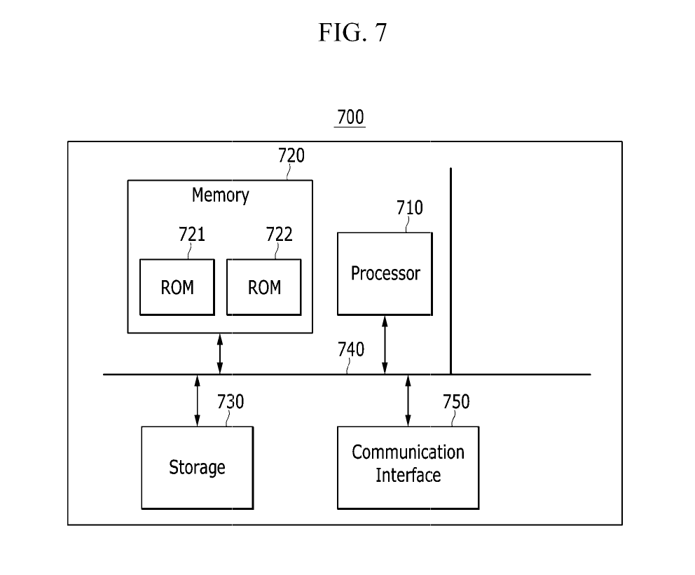

Meanwhile, an embodiment of the present invention may be implemented in a computer system, e.g., as a computer readable medium. As shown in in FIG. 7, a computer system 700 may include one or more of a processor 710, a memory 720, and a storage 730, each of which communicates through a bus 740. The computer system 700 may also include a communication interface 750. The processor 710 may be a central processing unit (CPU) or a semiconductor device that executes processing instructions stored in the memory 720 and/or the storage 730. The memory 720 and the storage 730 may include various forms of volatile or non-volatile storage media. For example, the memory 720 may include a read-only memory (ROM) 721 and a random access memory (RAM) 722. Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

According to an exemplary embodiment of the present invention, data may be transmitted and received at a high speed between several devices through a common serial line shared by the several devices, without time division

According to an exemplary embodiment of the present invention, data may be simultaneously transmitted and received between several devices without using a time division scheme.

According to an exemplary embodiment of the present invention, since communication between several devices is performed through a single serial line, connections for data transmission and reception between several devices may be simplified.

According to an exemplary embodiment of the present invention, an interface technique based on a parallel bus scheme of connecting several devices by using complicated parallel lines may be replaced.

According to an exemplary embodiment of the present invention, since several devices are simply connected on a system, the system may be simplified and miniaturized, and the number of input/output ports of the devices may be remarkably reduced. Since the number of input/output ports is reduced, power consumption due to input/output may be considerably reduced and convenience may be maximized.

An exemplary embodiment of the present invention may be used as an interface technique for data transmission and reception connection between devices of parts of products (a watch-type product, a necklace-type product, and the like) having a unique shape of a future world, products such as robots, or the like.

According to an exemplary embodiment of the present invention, connectivity between chips may be improved in fields of a package on package (PoP) or multi-chip package (MCP) in which several chips are integrally packaged.

An exemplary embodiment of the present invention may be used as a common and fast interconnection technique for connecting various hardware having various forms and objects in a field such as open source hardware (OSHW) manufactured by various subjects.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A first communication device comprising:
a symbol generator configured to modulate data to generate a first data symbol; and
a signal generator configured to generate a first signal using a first signal waveform allocated among a plurality of mutually orthogonal signal waveforms and the first data symbol, and output the first signal to a serial line connected to a second communication device.

2. The first communication device of claim 1, wherein:
the serial line adds up the first signal and a second signal output from the second communication device to mix the first and second signals; and
the second signal is generated by using a second signal waveform orthogonal to the first signal waveform among the plurality of signal waveforms.

3. The first communication device of claim 2, wherein
the signal generator comprises a first generator configured to generate the first signal waveform by cyclic-shifting a basic signal waveform among the plurality of waveforms by a first shift value corresponding to the first signal waveform.

4. The first communication device of claim 3, wherein the first generator generates the first signal waveform by using Equation 1 below:
φ₁(n)=φ₀(n+mod(S₁,N)) [Equation 1]
wherein φ₁ is a function for the first signal waveform, φ₀ is a function for the basic signal waveform, S₁ is the first shift value, N is a length of the first signal waveform, and n ranges from 0 to N−1.

5. The first communication device of claim 3, wherein the signal generator further comprises a second generator configured to generate the first signal by multiplying the first data symbol by the first signal waveform.

6. The first communication device of claim 5, wherein the mixed signal mixed by the serial line includes:
a first identifier identifying a device to receive a first packet corresponding to the first signal;
length information indicating a length of the first packet; and
a second identifier identifying a device transmitting the first packet.

7. The first communication device of claim 2, further comprising a reception processor configured to receive the mixed signal from the serial line and obtain data whose destination is the first communication device from the mixed signal.

8. The first communication device of claim 7, wherein when an identifier of a reception device of a first packet indicating a device to receive the first packet among packets included in the mixed signal indicates the first communication device, the reception processor extracts data from the first packet by using a basic signal waveform among the plurality of signal waveforms, and the first packet corresponds to the second signal.

9. The first communication device of claim 8, wherein when the identifier of a reception device of the first packet indicates the first communication device, the signal generator generates a response signal with respect to the first packet by using a third signal waveform corresponding to signal waveform information included in the first packet, among the plurality of signal waveforms, and outputs the response signal to the serial line.

10. The first communication device of claim 2, wherein in order to receive allocation of the first signal waveform, the signal generator generates a third signal requesting allocation of a signal waveform by using a third signal waveform reserved for an allocation request among the plurality of signal waveforms, and outputs the third signal to the serial line.

11. The first communication device of claim 2, further comprising a capacitor positioned between the signal generator and the serial line for capacitive coupling.

12. The first communication device of claim 11, wherein when the capacitor is formed within a semiconductor chip, the capacitor corresponds to a pattern formed between layers of the semiconductor chip.

13. The first communication device of claim 11, wherein when the capacitor is formed within a semiconductor chip package, the capacitor corresponds to a pattern formed on a substrate of the semiconductor chip package.

14. The first communication device of claim 11, wherein when the capacitor is formed outside of a semiconductor chip package, the capacitor comprises:
a first terminal in the form of a film; and
a support for preventing a short-circuit between the first terminal and a second terminal of a board

15. A first communication device comprising:
a waveform allocator configured to manage a plurality of mutually orthogonal signal waveforms, and allocate a first signal waveform among the plurality of signal waveforms to a second communication device among a plurality of communication devices connected to a serial line; and
a signal generator configured to generate a first signal by using allocation information of the first signal waveform and a second signal waveform among the plurality of signal waveforms, and output the first signal to the serial line.

16. The first communication device of claim 15, wherein when energy exists in a third signal waveform reserved for an allocation request among the plurality of signal waveforms, the waveform allocator determines that at least one of the plurality of communication devices requests allocation of a signal waveform.

17. The first communication device of claim 15, wherein:
the serial line adds up and mixes signals output from the plurality of communication devices; and
the first communication device further comprises a reception processor configured to receive the mixed signal from the serial line and extract information whose destination is the first communication device from the mixed signal,
wherein when the extracted information indicates transmission completion of the second communication device, the waveform allocator collects the first signal waveform.

18. The first communication device of claim 15, wherein the waveform allocator allocates the first signal waveform such that the second communication device can continuously use the first signal waveform, and collects the first signal waveform at a point in time when the second communication device does not require the first signal waveform.

19. The first communication device of claim 15, further comprising
a synchronization pulse generator configured to output a time synchronization pulse distinguished from the plurality of signal waveforms to the serial line at every predetermined number of frames, and
the frame corresponds to one period of the first signal waveform.

20. A communication method of a first communication device, the communication method comprising:
receiving allocation of a first signal waveform among a plurality of mutually orthogonal signal waveforms;
modulating data to generate a first data symbol;
generating a first signal by using the first signal waveform and the first data symbol and outputting the first signal to a serial line; and
receiving a mixed signal from the serial line,
wherein the mixed signal is a signal obtained by adding up the first signal and a second signal output from a second communication device connected to the serial line by the serial line.
